(19) United States
(12) Patent Application Publication
(10) Pub. No.: US 2015/0222672 A1
(43) Pub. Date: Aug. 6, 2015

(54) SITUATIONAL CROWD-SOURCED RESPONSE SYSTEM

(71) Applicants: Robert L. VAUGHN, Albuquerque, NM (US); Kay H. PHAMDO, Hillsboro, OR (US); Charles BARON, Chandler, AZ (US)

(72) Inventors: Robert L. Vaughn, Albuquerque, NM (US); Kay H. Phamdo, Hillsboro, OR (US); Charles Baron, Chandler, AZ (US)

(21) Appl. No.: 14/127,527

(22) PCT Filed: Sep. 9, 2013
(86) PCT No.: PCT/US13/58794

§ 371 Date: Dec. 19, 2013

(51) Int. Cl. H04L 29/06; H04L 29/08

(52) U.S. Cl. CPC H04L 65/403; H04L 67/10

(57) ABSTRACT

This disclosure is directed to a situational crowd-sourced response system. The system may comprise at least one crowd-sourced response management (CSRM) control device and CSRM devices for subscribers. An event may be reported by a CSRM device (e.g., through an event notification) or from an external reporting system (e.g., EAS). The at least one CSRM control device may then determine if CSRM devices are in within a certain locational proximity to the event, credentials for the users of the proximate CSRM devices, etc., and may form response groups based on these determinations. At least one response group may then be activated to provide aid in regard to the event. Users may also be requested to confirm compliance with the response instructions so that, if necessary, additional response groups may be activated. Sensor and/or communication resources in the CSRM devices may be activated to coordinate crowd-sourced aid, emergency services, etc.

### TECHNICAL FIELD

The present disclosure relates to event response systems, and more particularly, to a system for interacting with, organizing and managing crowd-sourced respondent to an event.

### BACKGROUND

“Crowdsourcing” is generally understood to be the practice of obtaining information, services, ideas, opinions, content, etc. by way of soliciting contributions directly from people in a community (e.g. the crowd). Businesses, educational institutions, social media, public and/or private organizations, authors, journalists, etc. may employ crowdsourcing as a vehicle by which the abilities of many individuals may be leveraged collaboratively through the use of modem technology such as, for example, wide-area networking (WAN) like the Internet.

Crowdsourcing may be employed in a variety of different fields and contexts. For example, crowdsourcing may be used in knowledge discovery and knowledge management wherein a crowd may be mobilized to find and assemble information. Crowdsourcing may also be useful for distributed information processing wherein a crowd may process and/or analyze data. Additionally, crowdsourcing may be useful in peer-vetted creative production (e.g. for creative problem solving wherein a crowd is mobilized to come up with solutions to a problem which has an answer that may be subjective or dependent on public support).

One area in which crowdsourcing-type systems have been applied on a national scale is for informing the public regarding missing children. The America's Missing: Broadcast Emergency Response (AMBER) Alerting System may employ various automated measures such as electronic road signs, opt-in wireless messaging notifications, etc. to request that the public to be on the lookout for missing children. While this system works very well for the purpose it is intended (e.g., to communicate missing children information to the public), it is not readily applicable to other events. The AMBER Alert System and other public address systems such as The Emergency Alert System (EAS) do not comprise a scalable framework for situational determination, organizing available resources, determining responder skillsets, conveying event-related data between victims, responders, emergency service providers, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example device comprising a situational crowd-sourced response system in accordance with at least one embodiment of the present disclosure;

FIG. 2 illustrates an example configuration for devices usable in accordance with at least one embodiment of the present disclosure;

FIG. 3 illustrates an example crowd-sourced response management (CSRM) client module in accordance with at least one embodiment of the present disclosure;

FIG. 4 illustrates an example crowd-sourced response management (CSRM) control module in accordance with at least one embodiment of the present disclosure;

FIG. 5 illustrates example operations for user device in a situational crowd-sourced response system in accordance with at least one embodiment of the present disclosure; and

FIG. 6 illustrates example operations for at least one control device in a situational crowd-sourced response system in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a situational crowd-sourced response system. In one embodiment, the system may comprise at least one crowd-sourced response management (CSRM) control device and CSRM devices for CSRM system subscribers. The occurrence of an event may initiate activity in the system. The event may be reported by a CSRM device (e.g., through an event notification) or from an external reporting system (e.g., EAS). The at least one CSRM control device may then determine if CSRM devices are in within a certain locational proximity to the event, credentials for the users of the proximate CSRM devices, etc., and may form response groups based on these determinations. At least one response group may be activated to provide aid in regard to the event (e.g., via response instructions sent to the CSRM devices). In one embodiment, users may be requested to confirm their compliance with the response instructions so that, if necessary, additional response groups may be activated. Sensor and/or communication resources in the CSRM devices of victims, responders, etc. may be activate to coordinate crowd-sourced aid, emergency services, etc.

In one embodiment, at least one device may comprise, for example, a communication module and a CSRM control module. The communication module may be to at least one of transmit data to, or receive date from, devices that are part of a CSRM system. The CSRM control module may be to determine that art event has occurred and to determine locational proximity of the CSRM devices to the event. The CSRM module may then be to organize the CSRM devices into response groups based at least on their locational proximity to the event and to cause event data to be transmitted via the communication module to at least one response group, the event data including at least response instructions.

In one example implementation, the CSRM control module being to determine that an event has occurred may comprise the CSRM control module being to receive an event notification from at least one CSRM device via the communication module. The CSRM control module may comprise at least a member maintenance module to at least maintain a database of users subscribed to the CSRM system and an event handling module to at least process event determinations. The member maintenance module may further be to verify credentials submitted by users subscribed to the CSRM system, the CSRM devices being organized into response groups also based on the credentials. The event handling module may further be to verify a context for the event. In one embodiment, the event data may further comprise a request for confirmation that a user associated with a CSRM device will comply with the response instructions. The CSRM control module may then further be to receive data from CSRM devices in the response group, to determine if the users associated with the CSRM devices in the response group will comply with the response instructions based on the received data, to activate at least one of sensor or communication resources in the CSRM devices associated with the users that will comply with the response instructions and to cause event data to be transmitted via the communication module to additional response groups based on the users that will not comply with the response instructions.

In one embodiment, a device may comprise a communication module and a CSRM client module. The communication module may be to at least one of transmit data to, or receive data from, at least one control device in a crowd-sourcing response management (CSRM) system. The CSRM client module may be to register the device with the CSRM system, the device registration including at least preferences for interaction with the CSRM system, to monitor for events or event notifications based on the preferences and to determine if at least one of an event has occurred or an event notification has been received based on the monitoring.

Example preferences may include at least one of preferences for communicating with the CSRM system or for permitting the CSRM system to access resources in the device. The CSRM client module may also be to transmit an event notification to the at least one CSRM control device if it is determined that an event has occurred, to present response instructions if it is determined that an event notification has been received, and to provide resources for confirming user compliance with the response instructions to the at least one CSRM control device. An example method consistent with present disclosure may include determining that an event has occurred, determining locational proximity of devices in a CSRM system to the event, organizing the CSRM devices into response groups based at least on their locational proximity and causing event data to be transmitted to at least one response group, the event data including at least response instructions. An additional example method consistent with the present disclosure may include registering a device with a CSRM system, the device registration including at least preferences for interaction with the CSRM system, monitoring for events or event notifications based on the preferences and determining if at least one of an event has occurred or an event notification has been received based on the monitoring.

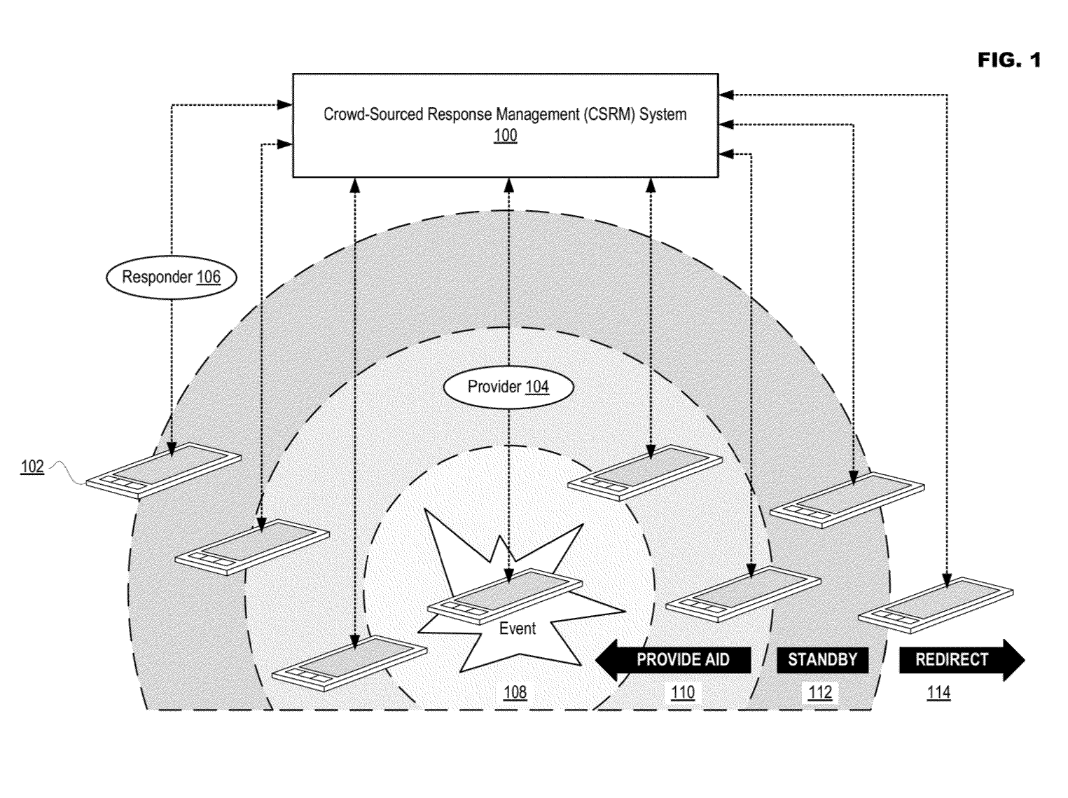

FIG. 1 illustrates an example device comprising a situational crowd-sourced response system in accordance with at least one embodiment of the present disclosure. Initially, it is important to note that the term “event,” as referenced herein, may refer to any occurrence that may involve responsive action. While events may include emergency situations involving a person or people, this example is merely for the use of explanation. Embodiments consistent with the present disclosure may apply to any happening involving the public. CSRM system 100 may interact with various devices 102 to, for example, detect the occurrence of an event, collect data about the event, organize responsive actions to address the event, track status of event responding, etc. An example CSRM system 100 may comprise one or more computing devices (e.g. servers) accessible via a WAN like the Internet (e.g., in a cloud computing-type architecture). Various examples of device 102 may include, but are not limited to, a mobile communication device such as a cellular handset or a smartphone based on the Android® operating system (OS), IOS®, Windows® OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a notebook, a laptop, a palmtop, etc., a stationary computing device such as a desktop computer, a set-top device, a smart television (TV), etc.

In one embodiment, users may voluntarily subscribe to CSRM system 100. A single type of subscription may exist or different subscription types. For example, in a single-type subscription model users may simply agree to participate in CSRM system 100 by making their device 102 available for sensing event data, responding to event instructions, etc. In a multiple-subscription model, users may subscribe for event coverage (e.g., for users that may have a medical condition, live in a remote area, etc.), or alternatively, as responders to events (e.g., to provide support for local emergency services). Users subscribing for event coverage may provide, for example, details regarding their situation (e.g., medical information, daily routine, etc.), and may pay a voluntary or required fee to receive service. Users subscribing as responders may provide, for example, details regarding their skillset availability etc.

In general, CSRM system 100 may determine an event has occurred and may organize a response to the event using crowd-sourced resources. An event may be determined based on information provided from outside or inside the system. For example, CSRM system 100 may receive event information from national alert systems (e.g., AMBER alert, EAS, etc.), from local emergency service providers, etc. It may also be possible for at least one device 102 to provide information regarding an event (e.g., provider interaction 104). For example, a user in device 102 may manually trigger an event notification, sensors within (or at least coupled to) device 102 may detect an event, etc. Example sensor-based event detection may include, but is not limited to, biologic sensors coupled to device 102 may detect that a user is experiencing physiological difficulty (e.g., is experiencing choking, heart attack, stroke, etc), motion/acceleration/orientation sensors in device 102 may detect conditions consistent with a vehicular accident (e.g., bicycle, car, bus, etc.), a natural disaster (e.g., earthquake, tornado, forest fire, blizzard, etc.), etc. Regardless of how the event is detected, provider interaction 104 may include the continuous transmission of event-related data to CSRM system 100, and may include the activation of voice or text communications to interact with on-site personnel.

CSRM system 100 may respond to an event notification by mobilizing crowd-sourced responders. In one embodiment, CSRM system 100 may determine characteristics regarding the event (e.g., type of event, location, casualties, active emergency service response, etc.), and may organize crowd-sourced responders accordingly. For example, CSRM system 100 may determine regions 108-114 around the event in which responders may reside, and may determine the location of responders based on positioning resources associated with device 102 (e.g., Global Positioning System (GPS) resources, triangulation based on cellular tower interaction, short-range connectivity to an access point (AP), etc.). Based on a variety of factors including, for example, the number of possible responders in each region 108-114, skills associated with possible responders (e.g., medical credentials, etc.), emergency service response status, etc., CSRM 100 may form groups of devices and may distribute instructions to the groups via responder interaction 106. For example, responders at event location 108 and immediately outside the event location in region 110 may be instructed to provide aid in regard to the event. These event instructions may be transmitted to device 102 as part of the responder interaction 110. Moreover, possible responders in region 112 may be placed into a standby state to provide aid, if necessary. Possible responders in region 114 (e.g., outside of the effective area of the event) may be redirected away from the event. For example, in some circumstances it may be beneficial, to reduce the amount of people involved in an event (e.g., if the event could still be dangerous, to provide room for emergency service personnel, etc.), then potential responders in region 114 may be directed away from the event or to another event that may require responders. In one embodiment, event instructions may request that possible responders confirm their intent to respond. This request may assist CSRM system 100 in managing crowd-sourced responding. If responders in the first response group (e.g., responders in regions 108 and 110) do not confirm their intention to respond to the event, then CSRM system 100 may request additional assistance by transmitting event instructions to device 102 corresponding to potential responders in the next response group (e.g., devices 102 in region 112). For responders that confirm their intention to respond to the event, in one embodiment sensing and/or communication resources may be activated in devices 102. The activation of these resources (e.g., depending on preferences set up by the user) may allow CSRM system 100 to be apprised of recent developments related to the event, which allows for coordination and communication between victims, responders, emergency services, etc.

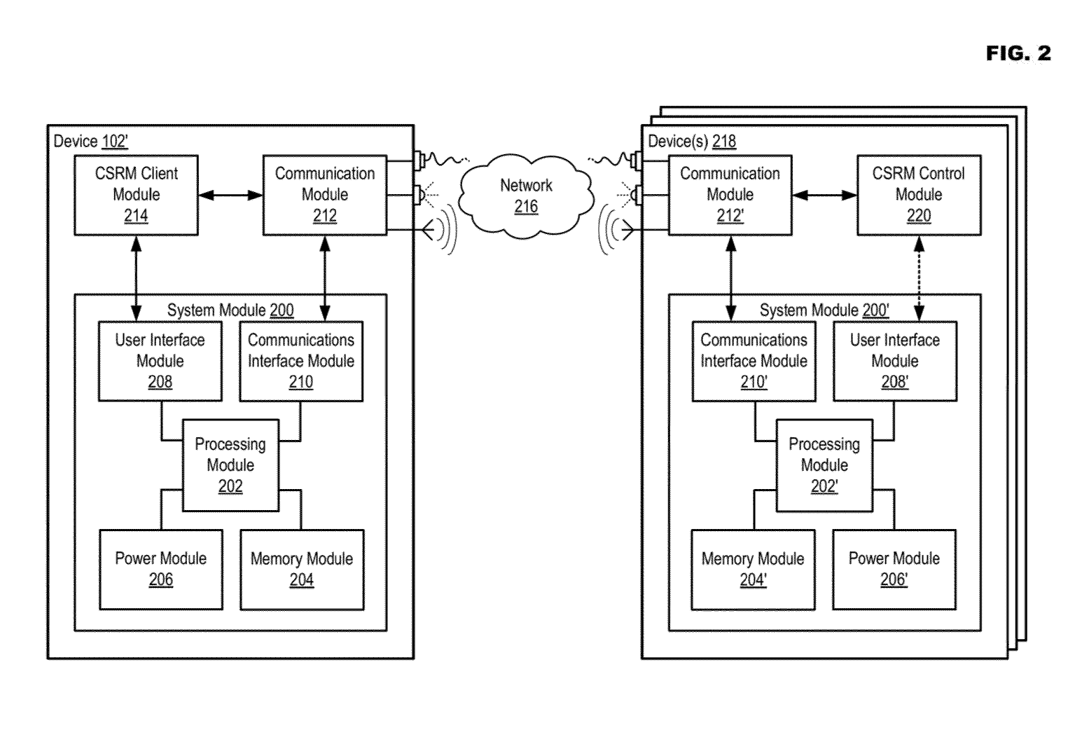

FIG. 2 illustrates an example configuration for devices usable in accordance with at least one embodiment of the present disclosure. In particular, while devices 102′ and 218 may perform example functionality such as disclosed in FIG. 1, devices 102′ and 218 are meant only as examples of equipment usable in accordance with embodiments consistent with the present disclosure, and are not meant to limit these various embodiments to any particular manner of implementation.

Example device 102′ may comprise system module 200 configured to manage device operations. System module 200 may include, for example, processing module 202, memory module 204, power module 206, user interface module 208 and communication interface module 210. Communication module 212 may be to interact with communications module 210, while CSRM client module may be to interact with user interface module 208 and communication module 212. While communication module 212 and CSRM client module 214 has been shown separately from system module 200, this arrangement is merely for the sake of explanation herein. Some or all of the functionality associated with communication module 212 and/or CSRM module 214 may also be incorporated within system module 200.

In device 102′, processing module 202 may comprise one or more processors situated in separate components, or alternatively one or more processing cores embodied in a single component (e.g., in a System-on-Chip (SoC) configuration), along with any processor-related support circuitry (e.g., bridging interfaces, etc). Example processors may include, but are not limited to, various x86-based microprocessors available from the Intel Corporation including those in the Pentium, Xeon, Itanium, Celeron, Atom, Core i-series product families. Advanced RISC (e.g., Reduced Instruction Set Computing) Machine or “ARM” processors, etc. Examples of support circuitry may include chipsets (e.g., North bridge, Southbridge, etc, available from the Intel Corporation) configured to provide an interface through which processing module 202 may interact with other system components that may be operating at different speeds, on different buses, etc, in device 102′. Some or all of the functionality commonly associated with the support circuitry may also be included in the same physical package as a microprocessor (e.g., in an SoC package like the Sandy Bridge integrated circuit available from the Intel Corporation).

Processing module 202 may be configured to execute various instructions in device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) and/or read-only memory (ROM) in a fixed or removable format. RAM may include memory configured to hold information during the operation of device 102′ such as, for example, static RAM (SRAM) or Dynamic RAM (DRAM). ROM may include memories such as bios memory configured to provide instructions when device 102′ activates in the form of bios, Unified Extensible Firmware Interface (UEFI), etc., programmable memories such as electronic programmable ROMs (EPROMS), Flash, etc. Other non-transitory fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), etc. Power module 206 may include internal power sources (e.g., a battery) and/or external power sources (e.g., electromechanical or solar generator, power grid, fuel cell, etc.), and related circuitry configured to supply device 102′ with the power needed to operate.

User interface module 208 may include circuitry configured to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, lighted/flashing indicators, electromechanical components for vibration, motion, etc.). Communication interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, wireless local area networking (WLAN), Wi-Fi, etc.) and long range wireless mediums (e.g., cellular wide-area radio communication technology, satellite technology, etc.). In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission.

In the embodiment illustrated in FIG. 2, CSRM client module 214 may be to interact with user interface module 208 and communication module 212. For example, CSRM client module 214 may cause event notifications and other event-related data to be transmitted via communication modules 212. CSRM client module 214 may also receive data such as event instructions via communication module 212. Data received via communication module 212 may be presented to a user via resources in user interface module 208 (e.g., a display, etc.). Moreover, in at least one embodiment the event instructions may request that a user confirm his/her intention to respond to the event. User interface module 208 may provide resources for allowing the user to respond (e.g., a user interface for indicating an intention to respond).

Device(s) 218 may be used to implement CSRM system 100. For example, device(s) 218 may comprise at least one computing device (e.g., a server) accessible via a network 216 like the Internet. Device(s) 218 may comprise modules 202′ to 212′ that may be analogous to the modules 202 to 212 disclosed with respect to device 102. CSRM control module 220 may be to perform activities such as disclosed in FIG. 1, and in that regard may interact with at least communication module 212′. For example, CSRM control module 220 may receive event-related data from devices 102, and may send event-related instructions to devices 102, via communication module 212′. Moreover, CSRM control module 220 may share data with emergency response services via communication module 212′ to coordinate event response efforts. CSRM control module 220 may, in some instances, also interact with user interface module 208′ to provide response stains to personnel in an emergency control center, etc.

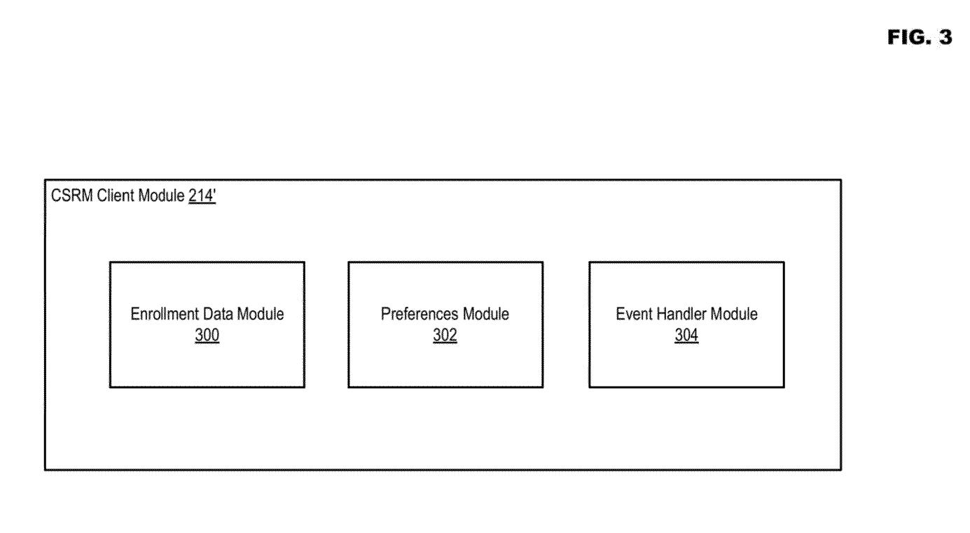

FIG. 3 illustrates an example CSRM client module in accordance with at least one embodiment of the present disclosure. CSRM client module 214′ may include, for example, an application installable by a user on device 102′. CSRM client module 214′ may comprise, for example, enrollment data module 300, preferences module 302 and event handler module 304. Enrollment data module 300 may be to allow a user to provide relevant data to CSRM system 100. For example, a user may provide contact information (e.g., telephone numbers, address, etc.), medical information (e.g., menial/medical conditions, doctors, etc.), skills (e.g., lifesaving skills, emergency service experience, etc.), credentials (e.g., military rank, medical doctor (MD), nurse practitioner (NP), emergency medical technician (EMT), etc.), etc.

Preferences module 302 may allow a user to set various parameters for participation including, for example, communication and sensing preferences. For example, a user may define times at which they are available to be a responded allowed forms of communication in order of preference, locations (e.g., home, work, etc.) wherein the user is not available as a responder, etc. Moreover, a user may desire to limit the sensor availability to CSRM system 100 (e.g., due to privacy concerns). By default, CSRM system 100 may desire to access all sensors in a device to determine device location, device movement/acceleration/orientation, device light/dark sensing, device temperature, etc. Upon the occurrence of any event, CSRM system 100 may seek to activate image/video capture and/or audio capture in device 102. A device user may desire to limit the amount of sensor access provided to CSRM system 100.

Event handler module 304 may be to process events detected by device 102′ and/or event instructions received from CSRM system 100. For example, event handler module 304 may process data from sensors in device 102′ and may prepare the data for transmission as part of an event notification. Event handler module 304 may also receive event instructions from CSRM system 100. Event handler module 304 may cause the event instructions to be presented by device 102′ (e.g., by user interface module 208), the event instructions telling users about the event, what to do immediately (e.g., seek shelter, leave the area, etc.) where to find aid, where aid may be required, to confirm whether they are able to provide aid, etc.

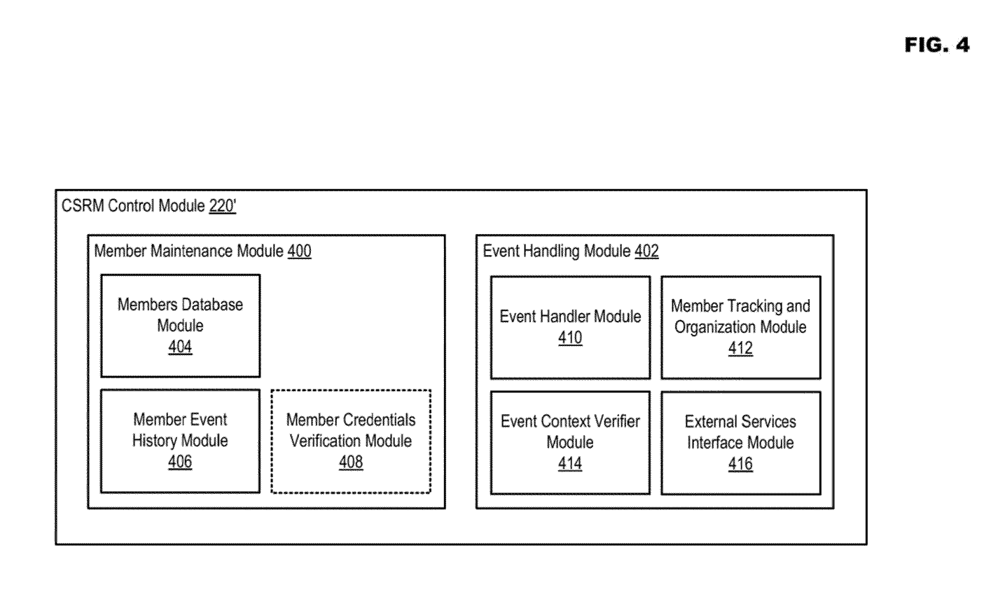

FIG. 4 illustrates an example CSRM control module in accordance with at least one embodiment of the present disclosure. Example CSRM control module 220′ may include member maintenance module 400 and event handling module 402. Member maintenance module 400 may be to maintain enrollment in CSRM system 100 and may include members database module 404, member event history module 406 and member credentials verification module 408 (e.g., which may be optional in accordance with some embodiments). Members database module 404 may comprise, for example, subscribed users, various data supplied by the subscribed users, data about devices 102, etc. Member event history module 406 may comprise, for example, a history of activity for users enrolled in members database module 404. The history of activity may include, for example, events reported by each user, events responded-to by each user, etc. As the events processed by CSRM system 100 may include emergency situations, there is a potential for some users (e.g., scam artists, hackers, terrorists, etc.) to take advantage of a bad situation to make it worse. Thus, it may be advantageous to incorporate protective features into CSRM system 100 to, for example, verify authenticity of users, event notifications, etc., to respond to possibly sensitive or dangerous events with the appropriate measures, etc. Further to access control measures like password protection, user identity confirmation (e.g., via personal, questions), intra-device and/or device-to-device data encryption, etc., member credentials verification module 408 is an example of a protective measure that may verify credentials provided by subscribed users. For example, a user may provide information that they are a licensed doctor, nurse, EMT, hazardous waste handler, etc. These credentials are desirable for a responder, and may cause CSRM system 100 to prioritize credentialed users above others when formulating response groups. However, if a user is not really credentialed (e.g., they are joking, just want attention, etc), requesting their assistance may be detrimental. Member credentials module 400 may interact with outside accreditation agencies to verify that users providing credentials are really credentialed, that their licenses are still valid, etc. This verification may provide an additional level of safety.

Event handling module 402 may be to handle events as they occur and may include event handler module 410, member tracking and organization module 412, event context verifier module 414 and external services interface module 416. Event handler module 410 may, for example, act as a general event-handling engine. Upon event notification event handler module 410 may interact with member tracking and organization module 412 and event context verifier module 414. Member tracking and organization module 412 may determine devices 102 within locational proximity to the event, determine the skills of users associated with devices 102 determine to be proximate to the event, and may determine at least one response group based on the above determinations. In one embodiment, historical performance for users may also be considered (e.g., users that confirm they intend to respond but do not actually respond may be deprioritized, excluded, etc). It is also possible that other factors may be determined in forming response groups, which is where event context verifier module 414 may become involved. Event context, verifier module 414 may include learning algorithms that help evaluate characteristics of the event and determine an appropriate type of response. For example, event context verifier module 414 may analyze events for situations posing potential security risks to responders. A device 102 that reports an event for the first time may require additional supportive evidence (e.g., confirmation from another device 102, national/local sources, etc.) before being acted upon. Event notifications from subscribers that have a history of overreaction or providing inaccurate information may be screened or deprioritized. Event notifications received from single male subscribers in isolated locations may result in event context verifier module 414 causing member tracking and organization module 412 to prioritize male responders over female responders. Event notifications that collect responders in a unusual and/or dangerous location or that indicate that the notifying device 102 is in a first geographic location and then a second geographic location separated by a distance not traversable in the time between indications (e.g., due to positioning signal spoofing, etc.), other sensors in device 102 that do not support the event notification (e.g., a vehicular accident is reported but the motion/acceleration/orientation sensors in device 102 do not support that conclusion) may cause event context verifier module 414 to perform a security action (e.g., the notification of local authorities as to a possible hoax, terrorist action, etc.). External services interface module 416 may maintain status data and communication between emergency service providers and CSRM system 100. For example, external services interface module 416 may communicate event-related data, data concerning crowd-sourced responders on the scene including information from the devices on on-scene responders, etc.

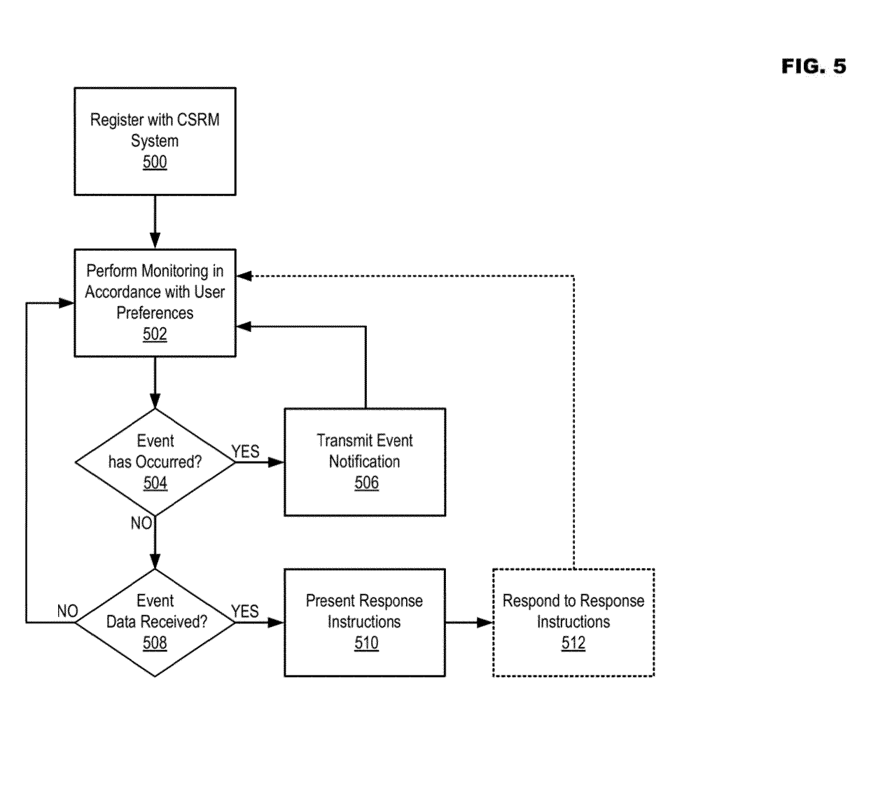

FIG. 5 illustrates example operations for user device in a situational crowd-sourced response system in accordance with at least one embodiment of the present disclosure. In operation 500, a user/device may subscribe to the CSRM system. For example, a subscribing user may provide personal data, medical data, skills data, device data, user preferences, etc. User preferences may, for example, dictate how/when/where the CSRM system may access the user device, may access sensors in the user device, etc. In operation 502 the user device may perform monitoring in accordance with the user preferences. A determination may then be made in operation 504 as to whether an event has occurred. This determination may be based on sensors in the device, the user observing an event and manually triggering activation of a CSRM client module in the device, etc. If in operation 504 it is determined that an event has occurred, then in operation 506 an event notification may be transmitted to the CSRM system. The event notification may include event-related data including, for example, time, location, event description, an accounting of injured persons, sensor data from the device, etc.

If in operation 504 it is determined that an event has not occurred, then in operation 508 a further determination may be made as to whether event data has been received from the CSRM system. If in operation 508 it is determined that an event alert has been received, then in operation 510 the device may present response instructions (e.g., received with the event data). Response instructions may indicate to the user the location of the event, the type of assistance needed, whether the user should respond to the event, seek shelter, flee the event area, etc. In some instances, the response instructions may request confirmation that a user receiving the response instructions intends to respond. Thus, in optional operation 512 a user may confirm his/her intention, to comply with the response instructions, which may cause the device to transmit an indication to the CSRM system regarding the user's intention. Following a determination in operation 508 that no event data was received, or alternatively, following operation 512, monitoring based on user preferences may resume in operation 502.

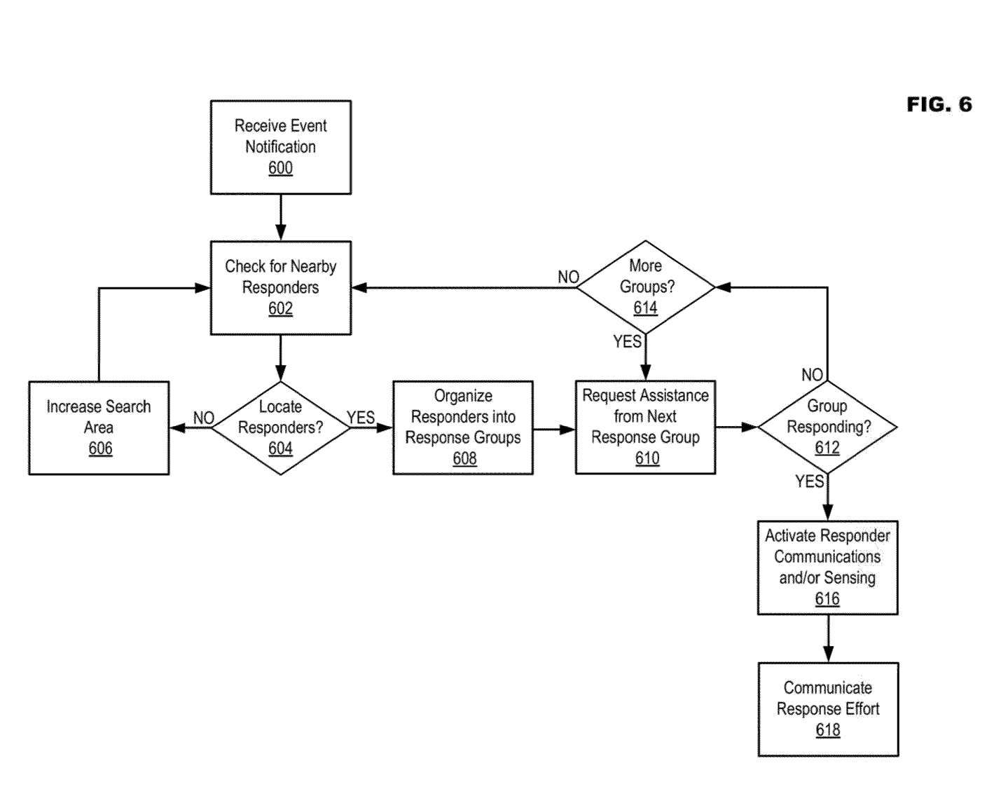

FIG. 6 illustrates example operations for at least one control device in a situational crowd-sourced response system in accordance with at least one embodiment of the present disclosure. In operation 600 an event notification may be received by the CSRM system. For example, event notifications may be received from devices subscribed to the CSRM system, from national/local notification systems, etc. The CSRM system may then check for nearby responders in operation 602. A determination may then be made in operation 604 as to whether any proximate responders have been located. If in operation 604 a determination is made that no responders were located, then in operation 606 the search area may be increased and the checking may continue. Upon locating some responders in operation 604, the CSRM system may then organize the responders into response groups in operation 608. Response groups may be organized based on, for example, proximity to the event, skillset, credentials, response history, etc. In operation 610 the CSRM system may request assistance from the next response group (e.g., may transmit event instructions requesting assistance to users in the response group). A determination may then be made in operation 612 as to whether the possible responders in the response group are intending to respond (e.g., intending to comply with event instructions requesting their assistance). If in operation 612 it is determined that not all of the users in the response group can/will respond, then in operation 614 a further determination may be made as to whether more response groups are available. If in operation 614 it is determined that more response groups are still available, then the CSRM system may request assistance from user in the next response group in operation 610. A determination in operation 614 that no response groups remain may be followed by a return to operation 602 to locate additional responders.

If in operation 612 it is determined that art adequate number of users in the response group intend to respond, then in operation 616 communication and/or sensor resources may be activated in the devices of the responders (e.g., based on the preferences established by the user during the subscription process). For example, voice interaction (e.g., speakerphone), locational services, image/video capture resources, motion sensing, etc. may be activated to provide information about the event, the responders, any victims, etc, to the CSRM system. The CSRM system may communicate response efforts in operation 618. For example, the CSRM system may interact with national/local emergency service providers to advise the situation on-scene (e.g., provide event-related data), advise on crowd-sourced response efforts, receive instructions from emergency service providers in regard to the event, etc.

While FIGS. 5 and 6 illustrates operations according to different embodiments, it is to be understood that not all of the operations depicted in FIGS. 5 and 6 are necessary for other embodiments. Indeed, it is fully contemplated herein that in other embodiments of the present disclosure, the operations depicted in FIGS. 5 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to a situational crowd-sourced response system. The system may comprise at least one crowd-sourced response management (CSRM) control device and CSRM devices for subscribers. An event may be reported by a CSRM device (e.g., through an event notification) or from an external reporting system (e.g., EAS). The at least one CSRM control device may then determine if CSRM devices are in within a certain locational proximity to the event, credentials for the users of the proximate CSRM devices, etc., and may form response groups based on these determinations. At least one response group may then be activated to provide aid in regard to the event. Users may also be requested to confirm compliance with the response instructions so that, if necessary, additional response groups may be activated. Sensor and/or communication resources in the CSRM devices may be activated to coordinate crowd-sourced aid, emergency services, etc.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a situational crowd-sourced response system, as provided below.

### Example 1

According to this example there is provided at least one device comprising a communication module to at least one of transmit data to, or receive data from, devices that are part of a crowd-sourcing response management (CSRM) system and a CSRM control module to determine that an event has occurred, determine locational proximity of the CSRM devices to the event, organize the CSRM devices into response groups based at least on their locational proximity to the event and cause event data to be transmitted via the communication module to at least one response group, the event data including at least response instructions.

### Example 2

This example includes the elements of example 1, wherein the CSRM control module being to determine that an event has occurred comprises the CSRM control module being to receive an event notification from at least one CSRM device via the communication module.

### Example 3

This example includes the elements of any of examples 1 to 2, wherein the CSRM control module being to determine that an event has occurred comprises the CSRM control module being to receive an event notification from an external notification system.

### Example 4

This example includes the elements of any of examples 1 to 3, wherein the CSRM control module comprises at least a member maintenance module to at least maintain a database of users subscribed to the CSRM system and an event handling module to at least process event determinations.

### Example 5

This example includes the elements of example 4, wherein the member maintenance module is further to verify credentials submitted by users subscribed to the CSRM system, the CSRM devices being organized into response groups also based on the credentials.

### Example 6

This example includes the elements of any of examples 4 to 5, wherein the member maintenance module is further to maintain a history of user activity for each user subscribed to the CSRM system.

### Example 7

This example includes the elements of any of examples 4 to 6, wherein the event handling module is further to verify a context for the event.

### Example 8

This example includes the elements of example 7, wherein the event handling module is further to at least one of organize the response groups also based on the event context or execute a security action based on the event context.

### Example 9

This example includes the elements of any of examples 4 to 8, wherein the event handling module is further to manage communications between external emergency service providers and the CSRM system.

### Example 10

This example includes the elements of any of examples 1 to 9, wherein the event data further comprises a request for confirmation that a user associated with a CSRM device will comply with the response instructions.

### Example 11

This example includes the elements of example 10, wherein the CSRM control module is further to receive data from CSRM devices in the response group, determine if the users associated with the CSRM devices in the response group will comply with the response instructions based on the received data and activate at least one of sensor or communication resources in the CSRM devices associated with the users that will comply with the response instructions.

### Example 12

This example includes the elements of example 11, wherein the CSRM control module is further to cause event data to be transmitted via the communication module to additional response groups based on the users that will not comply with the response instructions.

### Example 13

This example includes the elements of any of examples 1 to 12, wherein the event data further comprises a request for confirmation that a user associated with a CSRM device will comply with the response instructions, the CSRM control module being further to receive data from CSRM devices in the response group, determine if the users associated with the CSRM devices in the response group will comply with the response instructions based on the received data, activate at least one of sensor or communication resources in the CSRM devices associated with the users that will comply with the response instructions and cause event data to be transmitted via the communication module to additional response groups based on the users that will not comply with the response instructions.

### Example 14

This example includes the elements of any of examples 1 to 13, wherein the at least one device comprises at least one computing device accessible via a wide area network.

### Example 15

According to this example there is provided a device comprising a communication module to at least one of transmit data to, or receive data from, at least one control device in a crowd-sourcing response management (CSRM) system and a CSRM client module to register the device with the CSRM system, the device registration including at least preferences for interaction with the CSRM system, monitor for events or event notifications based on the preferences and determine if at least one of an event has occurred or an event notification has been received based on the monitoring.

### Example 16

This example includes the elements of example 15, wherein the preferences include at least one of preferences for communicating with the CSRM system or for permitting the CSRM system to access resources in the device.

### Example 17

This example includes the elements of any of examples 15 to 16, wherein the CSRM client module is further to transmit an event notification to the at least one CSRM control device if it is determined that an event has occurred.

### Example 18

This example includes the elements of example 17, wherein the event notification comprises event-related data including at least one of event time, event location and sensor data generated by sensors in the device.

### Example 19

This example includes the elements of any of examples 15 to 18, wherein the CSRM client module is further to present response instructions if it is determined that an event notification has been received.

### Example 20

This example includes the elements of any of examples 15 to 19, wherein the CSRM client module is further to provide resources for confirming user compliance with the response instructions to the at least one CSRM control device.

### Example 21

This example includes the elements of example 20, wherein the resources comprise a user interface for confirming user intention to comply with the response instructions.

### Example 22

This example includes the elements of any of examples 15 to 21, wherein the CSRM client module is further to present response instructions if it is determined that an event notification has been received and provide resources for confirming user compliance with the response instructions to the at least one CSRM control device.

### Example 23

According to this example there is provided, a method comprising determining that an event has occurred, determining locational proximity of devices in a crowd-sourcing response management (CSRM) system to the event, organizing the CSRM devices into response groups based at least on their locational proximity and causing event data to be transmitted to at least one response group, the event data including at least response instructions.

### Example 24

This example includes the elements of example 23, wherein determining that an event has occurred comprises receiving an event notification from at least one CSRM device.

### Example 25

This example includes the elements of any of examples 23 to 24, wherein determining that an even has occurred comprises receiving an event notification from an external notification system.

### Example 26

This example includes the elements of any of examples 23 to 25, and further comprises maintaining a database of users subscribed to the CSRM system.

### Example 27

This example includes the elements of example 26, and further comprises verifying credentials submitted by users subscribed to the CSRM system, the CSRM devices being organized into response groups also based on the credentials.

### Example 28

This example includes the elements of any of examples 26 to 27, and further comprises maintaining a history of user activity for each user subscribed to the CSRM system.

### Example 29

This example includes the elements of any of examples 23 to 28, and further comprises verifying a context for the event.

### Example 30

This example includes the elements of example 29, further comprising organizing the response groups also based on the event context or executing a security action based on the event context.

### Example 31

This example includes the elements of any of examples 23 to 31, wherein the event data further comprises a request for confirmation that a user associated with a CSRM device will comply with the response instructions.

### Example 32

This example includes the elements of example 33, and further comprises receiving indications from CSRM devices in the response group, determining if the users associated with the CSRM devices in the response group will comply with the response instructions based on the received indications and activating at least one of sensor or communication resources in the CSRM devices associated with the users that will comply with the response instructions.

### Example 33

This example includes the elements of example 32, and further comprises causing event data to be transmitted via the communication module to additional response groups based on the users that will not comply with the response instructions.

### Example 34

This example includes the elements of any of examples 23 to 33, wherein the event, data further comprises a request for confirmation that a user associated with a CSRM device will comply with the response instructions, the method further comprising receiving indications from CSRM devices in the response group, determining if the users associated with the CSRM devices in the response group will comply with the response instructions based on the received indications, activating at least one of sensor or communication resources in the CSRM devices associated with the users that will comply with the response instructions and causing event data to be transmitted via the communication module to additional response groups based on the users that will not comply with the response instructions.

### Example 35

According to this example there is provided a method comprising registering a device with a crowd-sourcing response management (CSRM) system, the device registration including at least preferences for interaction with the CSRM system, monitoring for events or event notifications based on the preferences and determining if at least one of an event has occurred or an event notification has been received based on the monitoring.

### Example 36

This example includes the elements of example 35, wherein the preferences include at least one of preferences for communicating with the CSRM system or for permitting the CSRM system to access resources in the device.

### Example 37

This example includes the elements of any of examples 35 to 36, and further comprises transmitting an event notification if it is determined that an event has occurred.

### Example 38

This example includes the elements of example 37, wherein the event notification comprises event-related data including at least one of event time, event location and sensor data generated by sensors in the device.

### Example 39

This example includes the elements of any of examples 35 to 38, and further comprises presenting response instructions if it is determined that an event notification has been received.

### Example 40

This example includes the elements of example 39, and further comprises providing resources for confirming user compliance with the response instructions.

### Example 41

This example includes the elements of any of examples 35 to 40, and further comprises presenting response instructions if it is determined that an event notification has been received and providing resources for confirming user compliance with the response instructions.

### Example 42

According to this example there is provided a system including at least a device, the system being arranged to perform the method of any of the above examples 23 to 41.

### Example 43

According to this example there is provided a chipset arranged to perform the method of any of the above examples 23 to 41.

### Example 44

According to this example there is provided at least one machine readable medium comprising a plurality of instructions that, in response to be being executed on a computing device, cause the computing device to carry out the method according to any of the above examples 23 to 41.

### Example 45

According to this example there is provided a device configured for use with a situational crowd-sourced response system, the device being arranged to perform the method of any of the above examples 23 to 41.

### Example 46

According to this example there is provided a device having means to perform the method of any of the above examples 23 to 41.

1-25. (canceled)

26. At least one device, comprising:
a communication module to at least one of transmit data to, or receive data from, devices that are part of a crowd-sourcing response management (CSRM) system; and
a CSRM control module to:
determine that an event has occurred;
determine locational proximity of the CSRM devices to the event;
organize the CSRM devices into response groups based at least on their locational proximity to the event; and
cause event data to be transmitted via the communication module to at least one response group, the event data including at least response instructions.

27. The at least one device of claim 26, wherein the CSRM control module comprises at least a member maintenance module to at least maintain a database of users subscribed to the CSRM system and an event handling module to at least process event determinations.

28. The at least one device of claim 27, wherein the member maintenance module is further to verify credentials submitted by users subscribed to the CSRM system, the CSRM devices being organized into response groups also based on the credentials.

29. The at least one device of claim 27, wherein the event handling module is further to verify a context for the event.

30. The at least one device of claim 26, wherein the event data further comprises a request for confirmation that a user associated with a CSRM device will comply with the response instructions, the CSRM control module being further to:
receive data from CSRM devices in the response group;
determine if the users associated with the CSRM devices in the response group will comply with the response instructions based on the received data;
activate at least one of sensor or communication resources in the CSRM devices associated with the users that will comply with the response instructions; and
cause event data to be transmitted via the communication module to additional response groups based on the users that will not comply with the response instructions.

31. A device, comprising:
a communication module to at least one of transmit data to, or receive data from, at least one control device in a crowd-sourcing response management (CSRM) system; and
a CSRM client module to:
register the device with the CSRM system, the device registration including at least preferences for interaction with the CSRM system;
monitor for events or event notifications based on the preferences; and
determine if at least one of an event has occurred or an event notification has been received based on the monitoring.

32. The device of claim 31, wherein the preferences include at least one of preferences for communicating with the CSRM system or for permitting the CSRM system to access resources in the device.

33. The device of claim 31, wherein the CSRM client module is further to transmit an event notification to the at least one CSRM control device if it is determined that an event has occurred.

34. The device of claim 31, wherein the CSRM client module is further to:
present response instructions if it is determined that an event notification has been received; and
provide resources for confirming user compliance with the response instructions to the at least one CSRM control device.

35. A method, comprising:
determining that an event has occurred;
determining locational proximity of devices in a crowd-sourcing response management (CSRM) system to the event;
organizing the CSRM devices into response groups based at least on their locational proximity; and
causing event data to be transmitted to at least one response group, the event data including at least response instructions.

36. The method of claim 35, further comprising:
maintaining a database of users subscribed to the CSRM system; and
verifying credentials submitted by users subscribed to the CSRM system, the CSRM devices being organized into response groups also based on the credentials.

37. The method of claim 35, further comprising:
verifying a context for the event.

38. The method of claim 35, wherein the event data further comprises a request for confirmation that a user associated with a CSRM device will comply with the response instructions, the method further comprising:
receiving indications from CSRM devices in the response group;
determining if the users associated with the CSRM devices in the response group will comply with the response instructions based on the received indications;
activating at least one of sensor or communication resources in the CSRM devices associated with the users that will comply with the response instructions; and
causing event data to be transmitted via the communication module to additional response groups based on the users that will not comply with the response instructions.

39. A method, comprising:
registering a device with a crowd-sourcing response management (CSRM) system, the device registration including at least preferences for interaction with the CSRM system;
monitoring for events or event notifications based on the preferences; and
determining if at least one of an event has occurred or an event notification has been received based on the monitoring.

40. The method of claim 39, wherein the preferences include at least one of preferences for communicating with the CSRM system or for permitting the CSRM system to access resources in the device.

41. The method of claim 39, further comprising:
transmitting an event notification if it is determined that an event has occurred.

42. The method of claim 39, further comprising:
presenting response instructions if it is determined that an event notification has been received; and
providing resources for confirming user compliance with the response instructions.

43. At least one machine-readable storage medium having stored thereon, individually or in combination, instructions that when executed by one or more processors result in the following operations comprising:
determining that an event has occurred;
determining locational proximity of devices in a crowd-sourcing response management (CSRM) system to the event;
organizing the CSRM devices into response groups based at least on their locational proximity; and
causing event data to be transmitted to at least one response group, the event data including at least response instructions.

44. The medium of claim 43, further comprising instructions that when executed by one or more processors result in the following operations comprising:
maintaining a database of users subscribed to the CSRM system; and
verifying credentials submitted by users subscribed to the CSRM system, the CSRM devices being organized into response groups also based on the credentials.

45. The medium of claim 43, further comprising instructions that when executed by one or more processors result in the following operations comprising:
verifying a context for the event.

46. The medium of claim 43, wherein the event data further comprises a request for confirmation that a user associated with a CSRM device will comply with the response instructions, the medium further comprising instructions that when executed by one or more processors result in the following operations comprising:
receiving indications from CSRM devices in the response group;
determining if the users associated with the CSRM devices in the response group will comply with the response instructions based on the received indications;
activating at least one of sensor or communication resources in the CSRM devices associated with the users that will comply with the response instructions; and
causing event data to be transmitted via the communication module to additional response groups based on the users that will not comply with the response instructions.

47. At least one machine-readable storage medium having stored thereon, individually or in combination, instructions that when executed by one or more processors result in the following operations comprising:
registering a device with a crowd-sourcing response management (CSRM) system, the device registration including at least preferences for interaction with the CSRM system;
monitoring for events or event notifications based on the preferences; and
determining if at least one of an event has occurred or an event notification has been received based on the monitoring.

48. The medium of claim 47, wherein the preferences include at least one of preferences for communicating with the CSRM system or for permitting the CSRM system to access resources in the device.

49. The medium of claim 47, further comprising instructions that when executed by one or more processors result in the following operations comprising:
transmitting an event notification if it is determined that an event has occurred.

50. The medium of claim 47, further comprising instructions that when executed by one or more processors result in the following operations comprising:
presenting response instructions if it is determined that an event notification has been received; and
providing resources for confirming user compliance with the response instructions.
